(19) United States
(12) Patent Application Publication
(10) Pub. No.: US 2018/0246562 A1
(43) Pub. Date: Aug. 30, 2018

(54) Virtual Built Environment Mixed Reality Platform

(71) Applicant: David Seth Peterson, Palmwoods (AU)

(72) Inventor: David Seth Peterson, Palmwoods (AU)

(21) Appl. No.: 15/815,685

(22) Filed: Nov. 16, 2017

(30) Foreign Application Priority Data
Nov. 18, 2016 (AU) 2016904733

(51) Int. Cl. G06F 3/01; G06T 19/00; A63F 13/25; A63F 13/52

(52) U.S. Cl. CPC G06F 3/011; G06T 19/006; A63F 2300/8082; A63F 13/52; G06T 2219/024; A63F 13/25

(57) ABSTRACT

A method and system for linking virtual and physical activities. The method comprises providing a physical module comprising a board and at least one member that can be attached thereto, capturing, using a capture module, one or more first representations of the board and the at least one member attached thereto and mapping the captured one or more first representations to one or more second, virtual, representations, and allowing the user to make changes and share information in the physical module and updating, responsive to capturing a third representation of the physical module including said changes using the capture module, in one or more reconfigured fourth, virtual, representations according to capture information and criteria specified in a rules module, wherein the rules module specifies one or more interaction rules for interaction of a user with any one or more of the first, second, third and fourth representations.

### TECHNICAL FIELD

The present invention relates generally to the field of linking activities across physical and virtual worlds including building or updating aspects of the world(s) using a system platform. More specifically, the invention relates to a system for linking virtual and physical activities.

### BACKGROUND

Any mention and/or discussion of prior art throughout the specification should not be considered, in any way, as an admission that this prior art is well known or forms part of common general knowledge in the field.

With the technical improvements offered by virtual reality systems leading to superior user experience, physical games, for example board games or modular piece construction games, are facing a fundamental challenge to their existence. Whilst there may always be a place for games that exist entirely in the physical world, there is increasing competition from the allure of the virtual world. Predicting the demands of game users across both physical and virtual game worlds is proving difficult for game manufacturers.

Typical approaches to virtual gaming limit user ability to create free form, interactive environments with connection to the physical world. This curtails user exploration and expressiveness due to a static gaming platform where rules are generally fixed.

Embodiments of the present invention seek to address one or more of these limits.

### SUMMARY

In accordance with a first aspect of the present invention there is provided a system for linking virtual and physical activities comprising:

a physical module comprising a board and at least one member that can be attached thereto,

a capture module configured for capturing one or more first representations of the board and the at least one member attached thereto and maps the captured one or more first representations to one or more second, virtual, representations, and

a rules module,

wherein the physical module is configured for allowing the user to make changes and share information in the physical module and the capture module is configured for updating, responsive to capturing a third representation of the physical module including said changes, in one or more reconfigured fourth, virtual, representations according to capture information and criteria specified in the rules module, and

wherein the rules module is configured for specifying one or more interaction rules for interaction of a user with any one or more of the first, second, third and fourth representations.

In accordance with a second aspect of the present invention there is provided a method for linking virtual and physical activities comprising:

providing a physical module comprising a board and at least one member that can be attached thereto,

capturing, using a capture module, one or more first representations of the board and the at least one member attached thereto and mapping the captured one or more first representations to one or more second, virtual, representations, and

allowing the user to make changes and share information in the physical module and updating, responsive to capturing a third representation of the physical module including said changes using the capture module, in one or more reconfigured fourth, virtual, representations according to capture information and criteria specified in a rules module,

wherein the rules module specifies one or more interaction rules for interaction of a user with any one or more of the first, second, third and fourth representations.

### BRIEF DESCRIPTION OF THE DRAWINGS

FIG. 1 Schematic diagram illustrating a platform according to an example embodiment.

FIG. 1A Schematic illustration of the work-flow or modules according to an example embodiment.

FIG. 2 Schematic illustration of Side-scrolling Platformer example embodiment.

FIG. 2A Schematic illustration of Dungeon Knights and Dragons example embodiment.

FIG. 2B Schematic illustration of Horse Riding example embodiment.

FIG. 2C Schematic illustration of Mini-monster Trucks Smash example embodiment.

FIG. 2D Schematic illustration of Music example embodiment.

FIG. 2E Schematic illustration of Physics example embodiment.

FIG. 3 Schematic illustration of Augmented Reality/Mixed Reality Capture Phase according to an example embodiment.

FIG. 4 Schematic illustration of Object Recognition Module according to an example embodiment.

FIG. 5 Schematic illustration of Environment Engine according to an example embodiment.

FIG. 6 Schematic illustration of Rules Module according to an example embodiment.

FIG. 6A Schematic illustration of Rules Module Detail according to an example embodiment.

FIG. 7 Schematic illustration of Emergent Rules Detail according to an example embodiment.

FIG. 8 Schematic illustration of Swappable Rules Module according to an example embodiment.

FIG. 9 Schematic illustration of AR Visualisation according to an example embodiment.

FIG. 10 Schematic illustration of AR HMD according to an example embodiment.

FIG. 11 Schematic illustration of AR HMD Wall projection according to an example embodiment.

FIG. 12 Schematic illustration of Mobile 3rd Person Visualisation according to an example embodiment.

FIG. 13 Schematic illustration of AR Interaction according to an example embodiment.

FIG. 14 Schematic illustration of Mobile Interaction according to an example embodiment.

FIG. 15 Schematic illustration of Physical Interaction with Piece according to an example embodiment.

FIG. 16 Schematic illustration of Board Observer Module according to an example embodiment.

FIG. 17 Schematic illustration of a system for linking virtual and physical activities according to an example embodiment.

FIG. 18 Flowchart illustration a method for linking virtual and physical activities according to an example embodiment.

### DETAILED DESCRIPTION

Embodiments of the present invention described herein relate to an interactive gaming platform.

The platform system and associated technology according to an example embodiment generates a virtual overlay on top of a surface with detected objects for the purpose of free form user interactivity within a rule system displaying emergent behaviour. This free form nature is further identified by re-programmable rules, and a theme engine along with a loose coupling to objects and interactive mechanics resulting in emergent behaviour. Users may physically and virtually interact with the surface configuration and layout which advantageously results in a rules engine which adapts and updates environment mechanics in real-time. Environmental state changes within the detected environment are tracked with new relationships and dynamics computed on-the-fly. These dynamic systems taken together along with the visual representation create the Virtual Built Environment (VBE) according to example embodiments.

An emergent dynamic is created from the freedom of play within the system along with user choices/strategies. This emergent dynamic is not hard coded into the system in example embodiments, rather the emergent dynamic is the combination of rules and other core gameplay dynamics—which may be referred to as a second order game dynamic created by the interaction of first order game mechanics.

This emergent dynamic may materialise with or without direct player activity or involvement according to example embodiments. This emergent dynamic assists in making the VBE feel more alive and expansive to the user, novel combinations of interactions are increased and the resultant behaviour advantageously creates further interest and curiosity within the user. The emergent dynamic further allows for novel activities, missions and situations for the user to be involved with according to some embodiments.

In one embodiment, a user may interact with the platform by playing a fully realised game world where they are in control of what the world is, how the world acts, how things interact and what the bounds of the game are; things like the walls, floors, objects and characters. The user may control a virtual 3D character or avatar, deciding on what movements and interactions take place. During world creation, the user may control where the character starts, what the objectives of the game world are (if there are any objectives at all), what obstacles there may be, where certain objects appear including but not limited to power ups, secret items and coins along with the rules around how the virtual environment responds and acts within an emergent system. In such an embodiment, user interaction may take the form of physically altering the pieces such as removing, adding or moving a piece. User interaction may also be via an intermediate device such as a smart phone or tablet type device.

In other embodiments, interactive games may be themed as, but not limited to, vehicle racing, mini-monster truck rally, cave exploration, top-down dungeon style adventure where the board becomes the ground or floor and the structural elements are the walls and building elements, open world building experiences, top-down horse adventure where the board is the ground and structural elements are jumps, barrels, water and ponds.

In another embodiment, the user selects an ocean theme piece and places pieces to represent coral, some to represent caves and some to represent islands. The user then places a plurality of pieces that represent different fish species. The user may then activate the board and watch the simulation unfold in front of themselves. In this embodiment, the user physically places a new “reef” piece in an empty spot on the board and watches the virtual fish “discover” the new hiding location and settle in.

In another embodiment, music is created with a board and pieces that have a sound scape theme attached. The rules engine applies the interaction and mechanics to all found physical objects. The applied mechanics may respond to touch or collision by generating sound, music, samples or notes. The force of the touch along with placement of the touch provide constant feedback to the mechanics which then provide real-time alteration to things like pitch or volume. This feedback loop operates on all items and works on the physical and virtual objects. As an example, a user may activate the board with the result of a virtual track playhead being passed over the board on a defined path. As the virtual track playhead moves across the board, wherever it interacts with a found object it will activate the “play” behaviour on that object.

In a further embodiment, the user creates a physics simulation by assembling a board and pieces. The user places the pieces at angles with each other at a descending angle to the one below. The objective is to take virtual water flowing from a point on the top left of the board and collect it in a virtual bucket on the lower right hand side of the board. In another embodiment, the water as descried above may be replaced with marbles or bowling balls or bouncy balls.

“Play” as referred herein is defined as “Free movement within a system of constraints”. This definition encompasses a wide variety of activities, with examples of, but not limited to: video game types of interaction, exploration types of interaction, puzzle solving types of interaction, musical creation as well as creating a physics simulation and running it to see the dynamics unfold.

The following embodiments are meant only as indicators of the potential applications of the technology. The embodiments that follow are in no ways meant to limit the potential for novel combinations of layout, pieces, themes and rules.

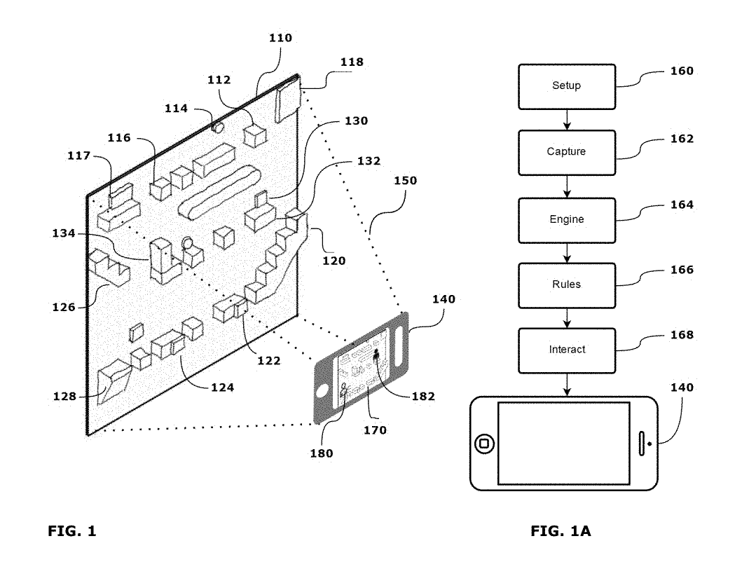

FIG. 1 schematically depicts a first embodiment showing a completed board 110 along with a plurality of pieces 112, 114, 116, 117, 120, 122, 124, 126 and 128, together referred to as a “setup”. Piece 112 may be a platform of ice, a power-up 114, a moveable platform 116, an in-game computer 117 for game puzzle, a set of stairs 120 and 126, an enemy spawn point 122 and 124, the avatar 128 start point and a theme piece 118. Piece 122 and 124 are stack pieces. All pieces are arranged to play a side-scrolling platformer type game 170. An Augmented Reality/Mixed Reality (AR/MR) type device 140 is used to capture the details 162 (compare FIG. 1A) from the board 110 and plurality of pieces. This captured data is sent to the Environment Engine implemented in the device 140 in this embodiment for the setup and creation of the VBE 170. Specifically, a rules engine also implemented in the device 140 in this embodiment uses the found board and piece data along with an applied theme to define the characteristics of the VBE, the mechanics and interactivity granted to the user. These rules and mechanics together create emergent behaviour within the VBE 170. User interaction is via the hand-held AR/MR device 140 with a multi-touch type screen in this embodiment.

In the first embodiment, a board 110 may serve as the underlying substrate for the creation of an interactive environment by being the base on which items or pieces may be attached 112, 114, 116, 117, 120, 122, 124, 126 and 128, 130, 132 and 134. A standalone surface of roughly defined bounds and generally lying on a plane may also suit. An example of this, but not limited to, would be a table top, floor, wall, picture, desk top, magazine, book or poster.

In some embodiments, board 110 may be of a static nature being made of materials such as, but not limited to, wood, plastic, paper, cardboard or any material sturdy enough to serve as the substrate for a plurality of pieces.

In other embodiments, the board 110 may contain a plurality of circuitry and sensors which combined create a framework or detection network that identifies placed pieces and recognises the placed Piece attributes. The embedded sensor network would respond to pieces that may also be static shapes or pieces themselves containing circuitry, sensors and/or transmitters. In this embodiment, the board may have embedded displays using common technology such as but not limited to LCD, OLED or similar. The board 110 may contain LEDs to further augment the feedback it can provide to the user. The board 110 may also contain a computer processing unit and may also have data transmission features that may use wireless and/or wired capabilities.

Generally, the board 110 may be set to a certain size and scale. Additionally, the board 110 may be of a square or rectangular type plane with a solid sturdy base of one or more colours. The colour of the board 110 may vary and its colour may have an influence on the theme and the rules applied to the game world. For example, but not limited to, a blue background may be a sky like environment for the user to fly a virtual character around and a grey coloured background may be a castle or dungeon. Although the colour of the board 110 may influence the game, it is not required and in other instances will have little or no impact on the actual interactive environment and rules.

In some embodiments, the board 110 may also have surface characteristics that make it easy to attach a plurality of pieces to it. The ability to attach additional elements or pieces is optional and may be of a fixed but detachable style attachment or a simpler placement that is not fixed.

Pieces e.g. 112, 114, 116, 117, 120, 122, 124, 126 and 128, 130, 132 and 134 are attached or arranged to be attached to the board 110. Such pieces or members then become part of the board 110.

The user may create their own navigable, interactive VBE by placing one or more pieces or level elements. The user may imagine floors, walls, stairs, moving platforms, jumping platforms, water and doors making up the created side-scrolling gaming world. Pieces may be arranged in any orientation or placement on the board that in any combination.

In some embodiments, pieces may be fastened or attached to the board by a number of methods. These methods may be, but not restricted to, studs and tubes, magnets, Velcro, sticky tape or any method of permanent, semi-permanent or non-permanent means. Pieces may also be placed on the board or surface without attachment of any kind.

In some embodiments, pieces may come in a plurality of shapes and sizes and may take the form of small brick likes structures in a common size and ratio as to make the placement of them easier and increase the number of unique placement combinations of said pieces. The pieces may also have attachment points on them to allow for other pieces to be stacked on one another.

In some embodiments, the pieces may be of a stylised nature. As an example, but not limited to, the pieces may have a ninja like motif or knights and dragons motif. Said pieces may be of a special shape with semantic significance and a known dimension and containing certain identifiable marks.

In some embodiments, a piece or pieces may have circuitry built in with a plurality of sensors, displays and LEDs to list just a few but not to limit the available circuitry and sensors devices. Pieces may also have computing ability along with transmission capability.

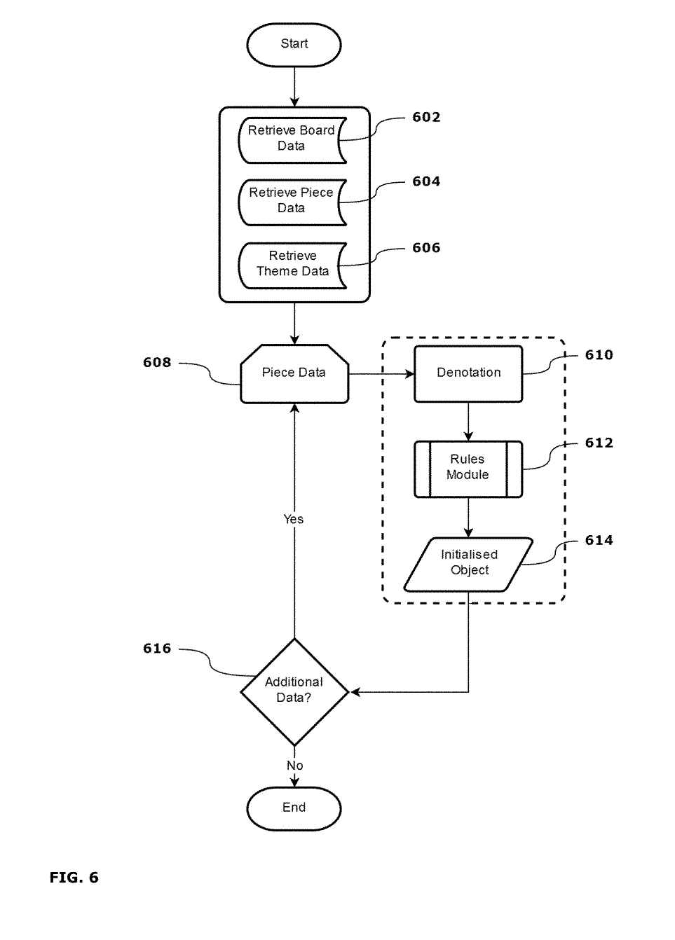

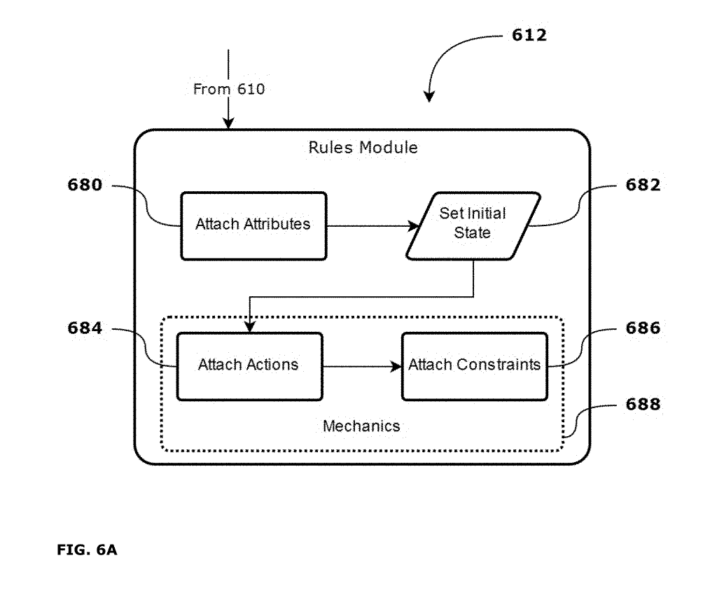

In some embodiments, a piece or pieces may take on the characteristics of a theme piece with said theme pieces being a visual representation of and influence on the underlying rules system as explained later in FIG. 6.

In some embodiments, a piece and combinations of pieces may offer distinct characteristics that relate to the theme and rules applied to the board 110. The connotated representation of said piece or combination of pieces in the VBE 170 may change per the theme and rules applied to the board 110. For example, but not limited to, in the first embodiment a side-scrolling platformer theme piece is in place. With said theme piece, certain physically placed pieces may have attributes that help define the VBE 170 and transform it into a side-scrolling platformer game 170 FIG. 1. In this example, a placed piece 130 instructs, through the rules module, piece 132 to have a connotated, virtual counterpart that is sticky and slows the player's velocity or may cause damage to the user's avatar. In another example still referring to FIG. 1, connotating piece 120 has the attributes and virtual appearance of stairs that may be climbed or the physical piece 114 may connate a rope that the user's avatar may be able to grab and swing from. It is noted to the reader that the previous examples are just a few amongst many other characteristics and behaviours of a side-scrolling platformer game according to an example embodiment. In another embodiment with a different theme piece 118 the placed physical pieces may have attributes that create creeks and streams, hills, jumps and barrels etc.

In some embodiments, pieces may have characteristics that are based on the shape of the piece and its relation to the board 110 and other pieces. These characteristics and connotated attributes may further be influenced by placed theme piece 118 or pieces and applied system rules. In some embodiments, the pieces are changeable and configurable.

The arrangement of pieces offers nearly limitless potential in creating built environments and gaming styles and genres all of which may combine and manifest in number of ways.

In some embodiments, along with combinations of a plurality of themes and rule systems, some pieces or combinations of pieces may define structural elements such as but not limited to platform surfaces 112, 116 and 132, walls 134, stairs 120 and 126.

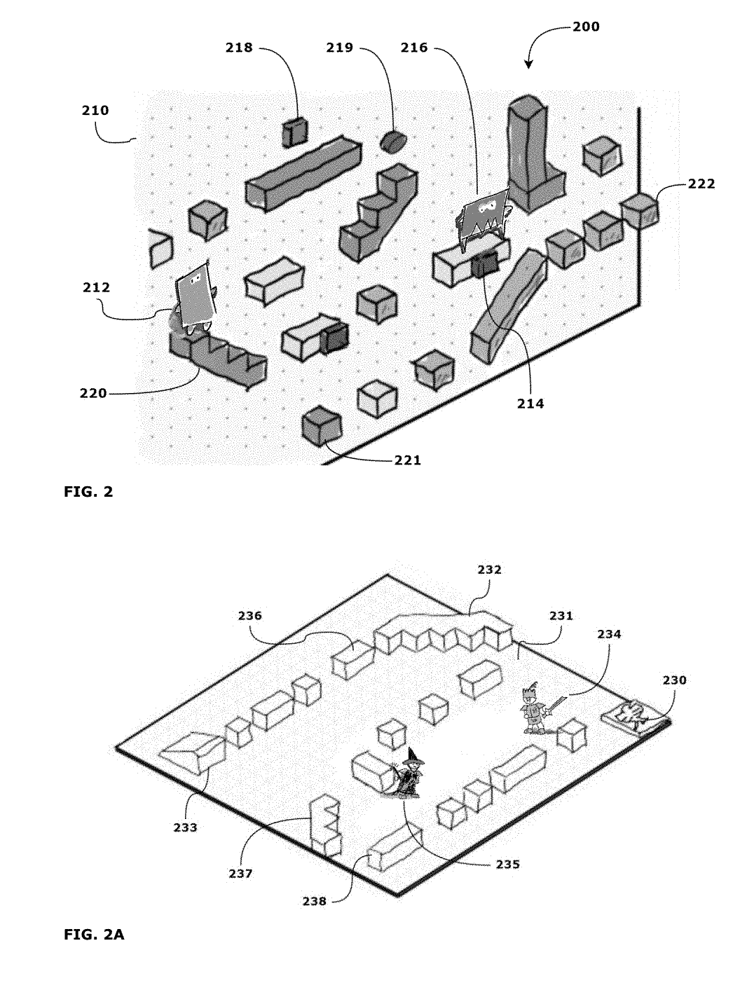

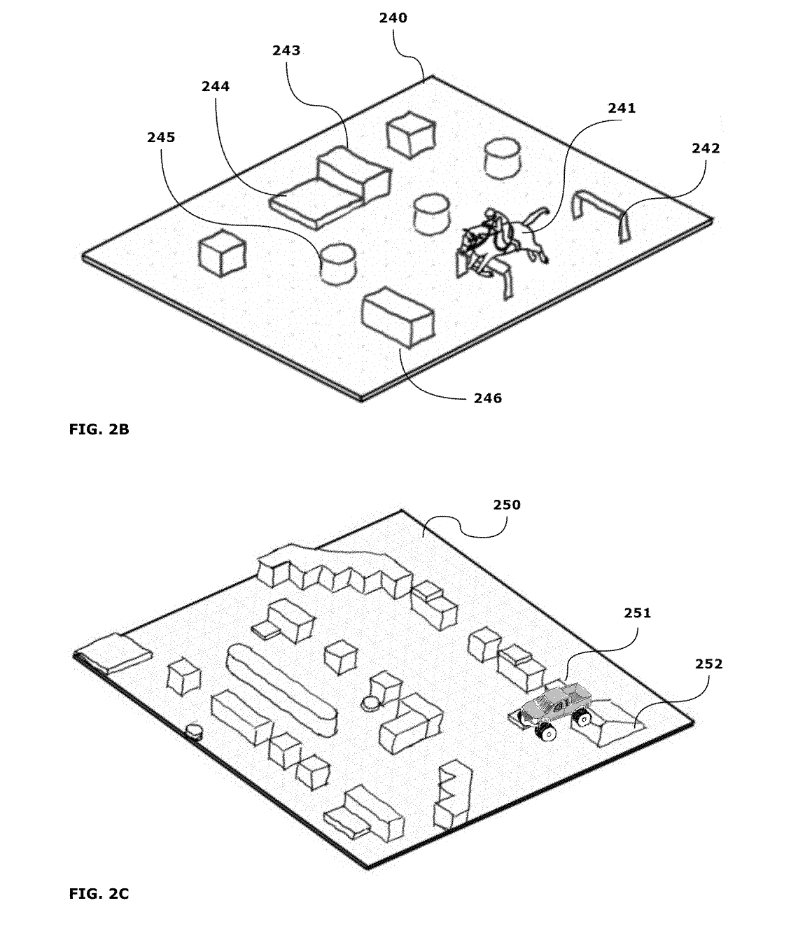

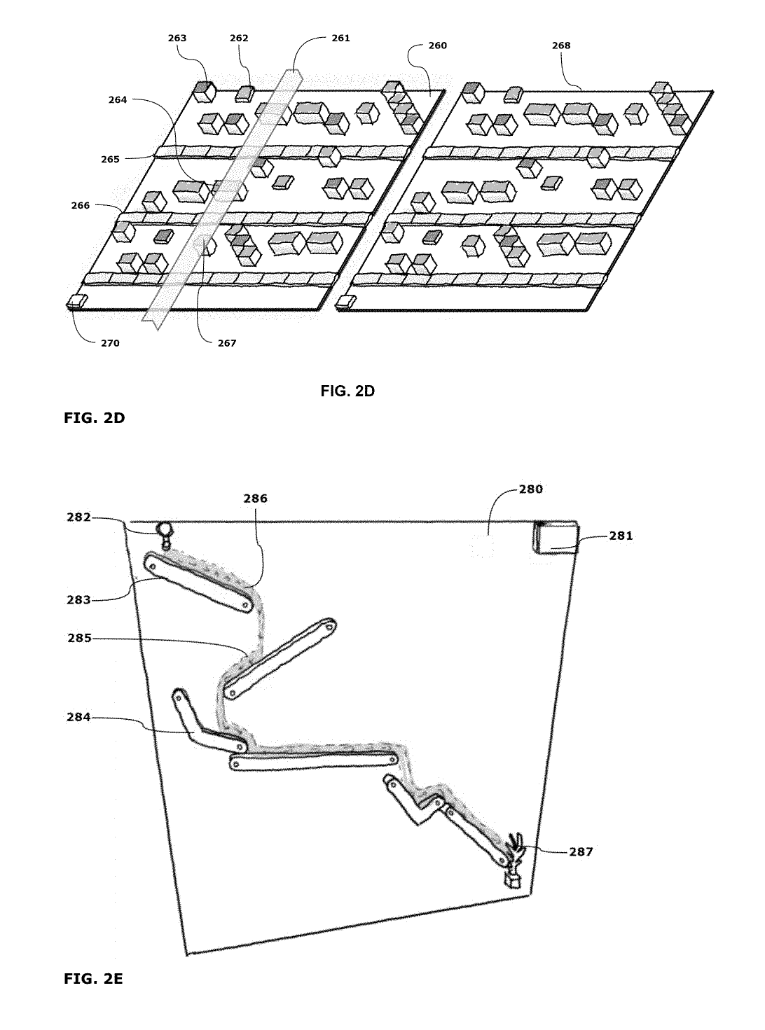

FIG. 2 is an example embodiment schematically showing a side-scrolling platformer game 200. Structural elements 220, 221 and 222 help define the bounds of where the user's avatar 212 can interact within, stand on and jump from as is understood in a side-scrolling platformer game.

In some embodiments with a game theme, obstacles may be put in the path of the user's avatar 212. The user may define obstacles by placing the pieces that will later on be connotated as obstacles in the rules system. Obstacles may be any number of things such as, but not limited to, autonomous enemy agents 216 or artificial intelligence (AI) elements that may move about the board with the objective of finding and interfering with the avatar from achieving their objective. Obstacles may also be traps, spikes or any other means to prevent the user from completing their set goals.

FIG. 2A is a schematic representation of a castle inspired knights and dragons style board layout. Theme piece 230 may be a specially shaped piece of a known dimension and may contain certain identifiable marks or may be a standard, non-descript piece with no significant markings. With said theme piece 230 in place, the rules system of the VBE are set as an interactive, top-down castle dungeon inspired quest game and structural pieces may be connotated from the top-down. In this embodiment, the user's avatar would take the form of a virtual knight 234, enemy agents would take on the appearance and attributes of evil giants, dragons or wizards 235. Collectable pieces may appear within the VBE as torches, arrows, swords, knives, treasure chests 236, traps, doors and gold coins. Structural pieces may appear within the VBE as stone floor 231, wood, brick 233, stone and castle walls 232, 237 and 238.

FIG. 2B is a schematic diagram of a board and pieces arranged for horse riding. Following along from the above example in FIG. 2A, the castle theme piece 230 is removed and replaced with a horse or farm style theme piece 244. With this new theme piece 244 in place, structural pieces may be transformed from being a castle wall or moat to be a flowing field 240 with jumps 242, hedges 243 and 246, barrels 245 and in this example, the theme piece is also represented as a pond 244. The user may control an avatar 241 that is riding a horse and performing jumps in an open field.

In another embodiment, the same physical board layout as 231 FIG. 2A is an underwater coral reef with previous walls, rooms and floors becoming reefs, islands, shipwrecks, and water, through use of an appropriate them piece.

FIG. 2C is a schematic diagram of a board and pieces arranged for monster truck smash racing according to one example embodiment. Board layout and pieces are a multi-player mini-monster truck crash course 250 with mini-monster trucks 251 racing around with the previous reefs, islands and shipwrecks, and water becoming stacks of crushed cars, jump ramps 252, mud pits and dirt tracks etc.

FIG. 2D is a schematic diagram of a board and pieces arranged for musical composition. Board 260 has been constructed with a plurality of pieces 262, 263, 265 and 266 along with a theme piece 270. Pieces 262 and 263 are examples of a piece that would play a note or sound. Pieces 265 and 266 denote a separate music “track” allowing for a sequence of music notes to be played simultaneously. Virtual playhead 261 passes over the physical board 260 and where playhead contacts pieces 264 and 267 said pieces send their respective “play” behaviour messages with the result being sound being output. Additional board 268 is an example where a user may have additional boards in a physical sequence with virtual playhead 261 moving towards board 268. A user may create a musical board 260 and capture it for future interaction, as shown in capture work-flow of module 162 in FIG. 1A. This process may allow user to sequence a plurality of saved boards in an arrangement of their choosing.

FIG. 2E is a schematic diagram of a physics type board layout. In this embodiment, the user places slopes and bars 283 and 284, and emitter 282/receiver 287 type pieces. A “water physics” type theme piece 281 is placed. In this example, the user is presented with a challenge: use a limited number of pieces to take “water” from the top left of the board 282 and put out a “fire” on the bottom right 287. The user places pieces to their choosing and once ready, activates the board. Virtual water flows from 282, using the computed volumes of the bar pieces to create surfaces on which the virtual water 286 and 285 can flow. The simulation runs for the user with water eventually making its way to the “fire” 287 and putting it out.

In another embodiment, the user is programming a physical robot with instructions and commands that are instructed by the assembly and placement of pieces on the board. In one example, the shelf pieces become action points with the robot being instructed to “go to” the relative real-world location based on the scale of the board, the slope pieces are obstacles with the robot being instructed to “avoid” those relative locations, the floor pieces instruct the robot to “turn 90 degrees clock-wise” with another instructing the robot to “turn 270 degrees counter-clockwise”.

Returning to FIG. 1, in some embodiments, the user may stack multiple pieces 122 and 124 FIG. 1 on one another or join them together by various means to create additional novel game features. Stacked pieces may indicate where certain game activities take place, certain goals and objectives that need to be met or serve the basis of solvable puzzles that need to be actioned in a sequence. Some combinations of stacked pieces may indicate points of interest for the user's avatar. These points of interest may be but not limited to power-ups, jet packs, super jumps, enemy spawn points, traps, triggers for puzzles, coins, collectable items.

In some combinations of theme(s) and rules, some pieces may take on the characteristics of a start piece 128, see FIG. 1. A start piece may define the start point or the spawn point of the user controlled avatar. This may be a piece with certain physical characteristics like shape and or colour or it may be any piece that has been selected by the user or by the selected theme or the selected rule systems applied to the board. Placing a start piece is optional, if one isn't placed or selected by the user, the system will determine the start point, according to example embodiments. If more than one start pieces are placed by the user or by the theme or rules system, said piece or pieces may serve as the basis of start points for one or more real-world users or for one more virtual AI agents in a multi-player environment. This may allow for more than one physical user to play or for more than one computer controlled agents to play. This play may be in a cooperative fashion or in a versus/competitive fashion.

In some combinations of theme(s) and rules systems, some pieces may take on the characteristics of a goal piece 117 FIG. 1. A “goal” is defined as what the user has to strive for. In a more general sense, a goal is an assignment of value to the possible outcomes of an interactive environment. Some embodiments enforce goals, while other embodiments have optional goals.

A plurality of goals may be set by the user or by the rules system based on the selected or default theme. If a goal piece is placed by the user or by the system, said piece may serve as the basis of achievements that need to be completed or activated by the user's avatar to progress in the game. If more than one goal is set, the user may select if said goal needs to be achieved in a certain order or any order or an order computed by the underlying theme and rules system.

Following on with the side-scrolling example, goal piece 117 is an in-game computer that needs to be accessed by the user's avatar to “unlock” the next level or board, according to an example embodiment.

In some embodiments, objectives may be, but are not limited to, completing a set number of goals or to reach a certain part of the world, it may also be to complete a set number of tasks within a certain period of time, or find a hidden piece or discover a set sequence of puzzles or triggers to unlock the exit or the free exploration of a world or a treasure hunt where the user needs to find up to a certain number of things before the world is complete and they have finished their goal.

In some combinations of theme(s) and rules, some pieces may take on the characteristics of a save point piece. If the avatar or computer agent activates a save point it may serve as the spawn point for the avatar in the case of a game restart.

In an example embodiment, along with combinations of themes, some pieces may take on the characteristics of a teleport type piece. A teleport piece may allow a user's avatar to travel to a new game level within an interlinked set of game levels.

Linked boards or levels may exist on the local computing system or may exist on additional physical boards that may be in proximity to the initial board. Linked boards or levels may be setup, captured and made interactive (compare work-flow or modules 160-168 in FIG. 1A) at any time. Interactive boards or levels (per work-flow or modules 160-168) may be created by the user, may be shared by the user or may be created by other users who have shared their levels and made them discoverable through services such as but not limited to social networks, email, SMS, QR code, stickers or any discoverable physical or non-physical means.

The VBE may be interlinked with a plurality of boards or levels. In some embodiments this will allow for a progression of playable environments after a set number of goals may be met, or a time exceeded or a puzzle solved or any number of novel combinations from pieces and rules. This progression may be along the lines of side-scrolling platformer where initial boards are less challenging and as the user progresses the challenges may get more and more difficult. This degree of challenge may be influenced by the theme and rules applied to the board or it may be influenced by the user themselves in customising the board, pieces and rules or may also be set to defaults.

FIG. 1A schematically illustrates a work-flow or modules according to an example embodiment, namely Setup 160, Capture 162, Engine 164, Rules 166 and Interaction 168 for implementation using a hand-held computing device such as a smart phone 140.

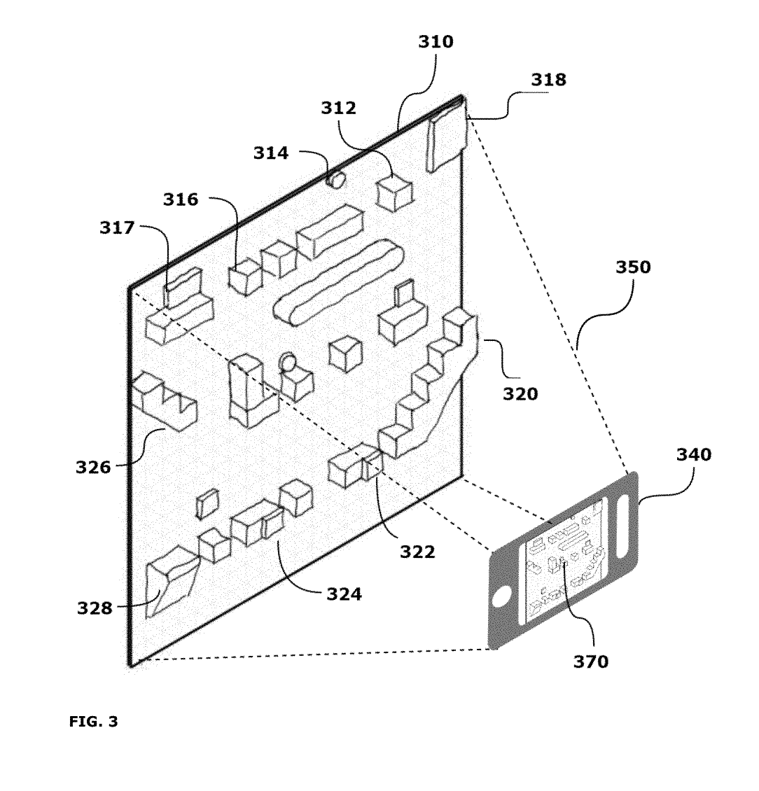

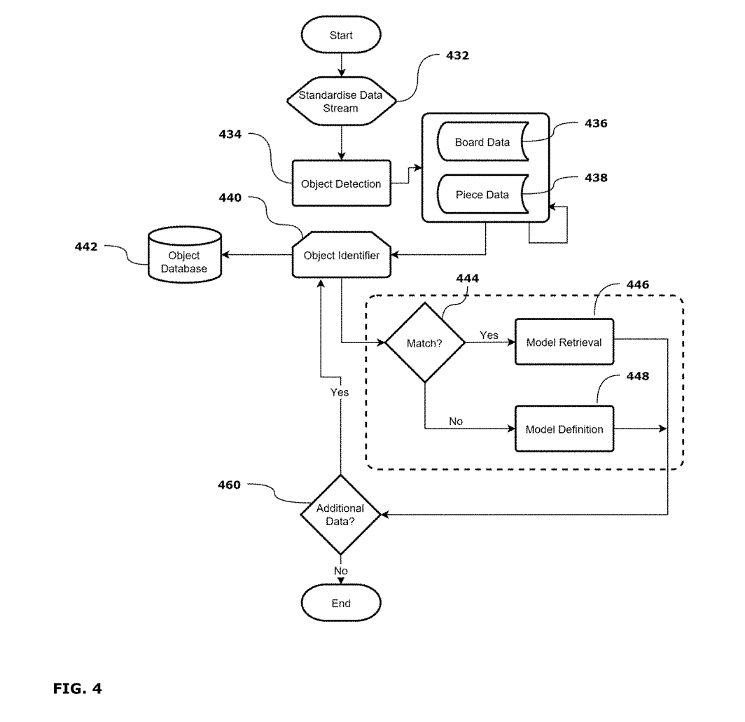

FIG. 3 depicts an AR/MR capture phase in accordance with an example embodiment of the present invention. An AR/MR device 340 is placed in front of the user and facing the board 310. This will allow the processing of the board by the AR/MR device 340. The systems and sensors of the AR/MR device 340 hardware may be used to collect object data which can then be converted to a standardised data stream or standardised data format (SDF) 432 FIG. 4. Systems and sensors may include: depth, orientation, infrared (IR) laser, colour, IR Video, texture mapping and depth projection to a world coordinate system.

The representation may then be converted to the VBE 370 so that a user may interact with it on a digital device such as, but not limited to, a computer phone, tablet, head mounted display, AR/MR system or dedicated gaming unit.

The AR/MR device 340 is used to create a digital representation of the detected physical environment, estimating in real-time the camera pose within a VBE coordinate system. The estimation process may also sometimes be called localisation or tracking and the creation of the digital representation of the observed environment may also be called reconstruction. Such reconstruction results in the creation of a point cloud or “3D map” of the scene. This is done on demand and is made available immediately for use to learn the surrounding on the fly and track objects in the scene automatically and in real-time.

In yet another embodiment, a method of capture is via an AR/MR type device that is worn on a part of the user's body. This may be on the user's head as a type of glasses or head mounted display (HMD) or may take on other forms. The user faces the direction of the board and looks at the board through the AR/MR device. Using the hardware and sensors of the underlying AR/MR system an immersive experience is presented to the user with virtual objects appearing as though they are directly existing within real-world physical space. The systems and sensors of the AR/MR hardware may be used to collect the object data and will be converted to a standardised data format as per 432 in FIG. 4.

Due to specific characteristics of the AR/MR device 340 according to an example embodiment, the data provided from the SDF 432 may create a real-time 3D spatial map and or point cloud to define the bounds of the interactive environment along with the identified objects contained with the defined board space as shown in 350 FIG. 3, and as per 434 as shown in FIG. 4. Further information may be captured from the AR/MR device 340 to define the board and plurality of attached pieces and their found characteristics as per 436 & 438 as shown in FIG. 4.

In another embodiment, a method of digital capture may be achieved by a user placing a digital scanning or imaging device in front of a board with a plurality of pieces. Image processing may occur on the digital scanning device or on a computing device like a computer, mobile device, tablet device or similar to convert the incoming data into the SDF as per 432 as shown in FIG. 4.

In another embodiment, a method of digital capture may be achieved by a user placing a plurality of sensors in front of the board. The plurality of sensors are employed to capture the characteristics and attributes of the board and any attached pieces or members. Data collected may include: depth, orientation, infrared, colour, infrared video, texture mapping, depth projection to a world coordinate system. and scale. This is just an example of the type of data that may be captured but other data types may also be captured from other sensor devices.

In a further embodiment, the board contains a plurality of circuitry and sensors which combined create a framework or detection network that identifies placed Pieces and recognises the placed Piece characteristics. This Board may also contain a computer processing unit and may also have data transmission features that may use wireless and/or wired capabilities. This Board with sensor network would respond to pieces that may also be static shapes or Pieces themselves containing circuitry, sensors and/or transmitters. In this embodiment, the board passes object data to a capture system for executing the work-flow or implementing the modules as shown in FIG. 4 and may have already converted it into the SDF (i.e. 432 as shown in FIG. 4 may already be performed or implemented by the board).

In one embodiment, object data is streamed into the capture system. This data is received by a stream formatter 432 which normalises the stream data (as it may come from many different sources) and converts it into a SDF. Once data is in the SDF it is passed to the object detection step or module 434. The object detection module 434 may identify the bounds of the VBE interactive space which may be roughly defined as the bounds of the board space 350 in FIG. 3. The VBE interactive space is the area that is observed by the capture system 350 in FIG. 3. This extracted board data 436 may be composed of a number of attributes such as, but not limited to, its extents, aspect ratio, colour and any found or implied theme. Once the extents of the interactive space are defined the object detection module 434 then identifies any pieces that are contained on the board. The identified pieces initially contain the raw piece data 438 as shown in FIG. 4. To augment this raw data, a number of data points may be detected (but not limited to): relative position of the piece, orientation relative to the board, shape, 3D extents/volume and colour.

Identified pieces, such as 322 and 324 in FIG. 3, that may have been placed on one another in a stacked arrangement may have their relationship identified and stored in a network graph with each identified piece being represented as a node and the connection being an edge. This graph will be attached as additional data 460 to the raw piece data 438.

Once the board and the plurality of pieces have been detected, the combined data is sent to the object identifier step or module 440. Within this module 440 the detected 3D vertices and characteristics of each individual raw piece data 438 is compared to an object database 442 of known 3D objects. A 3D model is the mathematical representation of any three-dimensional object and the model is formed from points in 3D space called vertices (or vertexes) that define the shape and form polygons.

If piece data is found to match 444 an object in the database 442, the full 3D model is retrieved 446 from the system which may be stored locally on the device 340 in FIG. 3 or retrieved from a separate storage system. This retrieved 3D model is a full virtual representation or connotation of the matched object.

In one embodiment, this match might be of a full 3D playable avatar 180 in FIG. 1 that the user will be able to control. The 3D model may be fully skinned with full image maps and textures, it may also have a full bone system allowing for freedom of movement within a set of constraints. In some embodiments, the matched 3D model may be a low polygon count model that serves the basis of a floor or as a jumping device to give the avatar greater vertical velocity. A reference to the retrieved 3D model is saved back to the piece data 438.

If a match 444 is not found for the piece data a new model definition 448 may be created. The model definition 448 may be created based on the shape, colour and position of the piece data based on stored SDF data 438. The model definition may additionally contain certain rules and instructions for what the 3D model representation should be within the VBE. These instructions may further be related to the derived 3D shape and coordinates, the relative position on the bard, any semantic relationships to other identified objects 434 and the material(s) which define how the user or other agents can interact with the model as well as how the model is represented visually within the VBE.

This next section describes the components of an environment engine 164 in FIG. 1A, according to an example embodiment.

The board and any placed objects or pieces provide the system with a number of data points 436 & 438 including but not limited to the size of the board, the colour of the board, the number of pieces, the colour and shape of the pieces, combined pieces, stacked pieces as well as the arrangement and orientation of pieces. These data points may help determine how said board and pieces are represented in the VBE as well as the virtual attributes and behaviours. These factors taken together form the basis of how the VBE operates, including but not limited to how objects interact with one another, how the user interacts with the virtual environment generally, what avatar controls are available or whether a controllable avatar is even present or required.

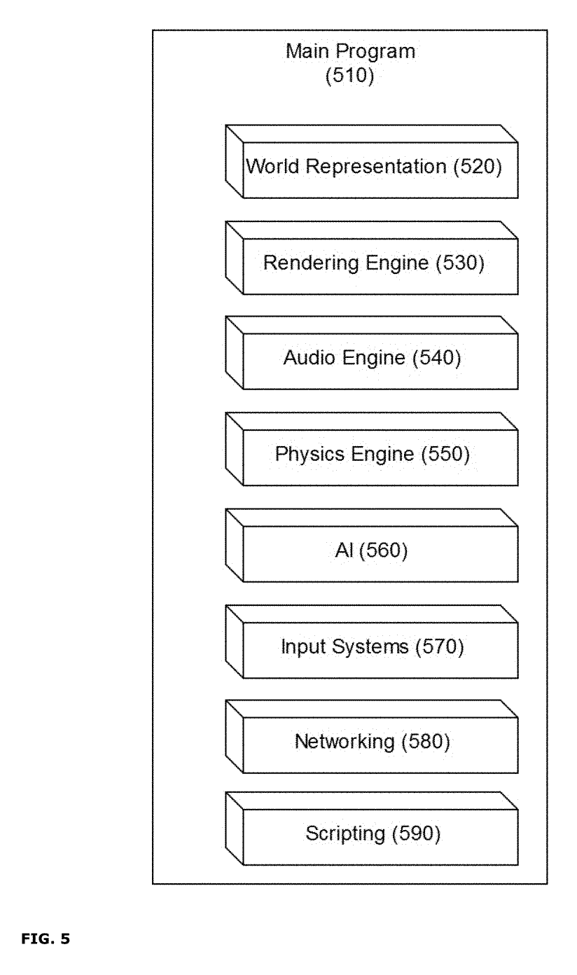

Referring to FIG. 5, this depicts a block diagram of an environment engine according to an example embodiment of the present invention. The engine is a software framework designed for the creation and development of interactive, digital experiences. The core functionality typically provided by the engine generally includes a rendering engine for 2D or 3D graphics, a physics engine or collision detection/response, sound, scripting, animation, artificial intelligence, networking, streaming, memory management, threading, localization support and scene graph. These abilities taken together allow for the creation of the VBE.

The Main program 510 is the core instruction sets and code modules that combined with various subsystems helps to create the unique and novel aspects of the VBE, according to an example embodiment.

The following is a non-exhaustive list of these subsystems, according to an example embodiment:

World Representation 520 is an aspect of a 3D engine which assists in tying together all the following subsystems. Its job is to abstractly represent the virtual world and the objects residing within it, allowing the main game program to reason about the specific embodiment. Typically, there is a system loop that is responsible for updating the state of the virtual environment on every frame.

Rendering Engine 530 outputs 3D graphics by the chosen method (rasterization, ray-tracing or any different technique). Instead of being programmed and compiled to be executed on the CPU or GPU directly, most often rendering engines are built upon one or multiple rendering application programming interfaces (APIs), such as Direct3D or OpenGL which provide a software abstraction of the graphics processing unit (GPU).

Audio engine 540 is the component which consists of algorithms related to sound.

Physics engine 550 is responsible for emulating the laws of physics realistically within the system.

Artificial Intelligence (AI) is available for controlling agents or NPCs (Non-Player Characters) and how the AI interacts within the virtual environment. This is usually accomplished with bundled or custom libraries and may be further extended through the engine's scripting system.

Input Systems 570 is an aspect of a 3D engine that typically recognise, process and make available user interaction via keystrokes, mouse clicks, screen gestures, hands free gestures or joystick movements.

Networking 580 allow for some sort of multiplayer support. Multiplayer support may be via split-screen on the same device or networked multiplayer which may need a client/server or peer-to-peer architecture either on your own, or with third-party libraries.

Scripting 590 an external logic may be written in familiar, established scripting languages such as but not limited to C#, Lua and Python or provide a custom text/flow-based language. System logic may be edited in a text editor, a custom IDE, or through an in-game developer console. A scripting environment additionally allows for user created rules systems, object definitions and mechanics.

This next section describes the rules and relationships step or module 166 in FIG. 1 according to an example embodiment.

FIG. 6 is a block diagram of the rules system according to an example embodiment. Object data is initially retrieved in the SDF format 332 from the object recognition system, refer to FIGS. 3 & 4, with the unprocessed board data, unprocessed piece data 604 and theme data 606 being stored in a system accessible storage method. Board data may consist of, but not limited to the aspect ratio along with the number of units along both the X and Y axis and colour. Piece data may consist but not limited to of relative piece position, relative piece orientation, 3D model (known 3D object or identified extents/volume), colour and any relationships. Theme data 606 may consist of but not limited to any found or implied theme. Once all data has been retrieved it is available for further processing.

In some embodiments, the theme may be a piece of certain characteristics that may be physically placed on the board, as per 118 in FIG. 1. The theme may also be computationally derived from the attributes of the board along with the number, attributes and arrangement of found pieces. In some embodiments, the board may also have a default theme if none is detected or derived. In some other embodiments, there may be no theme.

In some embodiments, the theme may form the visual representation of the rules system along with influencing the look and feel of the virtual environment, refer to 530 in FIG. 5, the mechanics as well as other characteristics that define the entire interactive VBE. In one embodiment, a user may place a theme piece on the board that may transform the entire virtual world representation into a side-scrolling platformer game. In another embodiment, a user may place a theme piece that creates a field with jumps and barrels ready for a virtual avatar to ride through.

Referring to FIG. 6, the retrieved piece data 604 is further processed in an iterative loop 608. This process loops over the piece data item by item until all data has been processed. The output of each run of the loop is fully initialised VBE object 614 ready for user interaction. Within this loop the denotation system 610 acts on each individual piece taking the outputted data 430 and maps it to the connotation or semantic meaning of the piece as it would exist inside a fully realised VBE.

In some embodiments, the denotation system 610 takes the found object and denotes what the base element is within the VBE. Denotation may use object data 604 combined with the theme 606 and denote that a found object 222 FIG. 2 certain characteristics connotates a block of ice within the VBE. In this example the user may have placed a flat, clear plastic piece on the board. The user understands that this piece has semantic meaning of ice and by placing said object that the representation within the VBE will be that of a platform made of ice. Following along with this example, the rules module 612 may apply additional attributes to give the denotated piece it a slippery material with low friction. Within the VBE, this low friction may cause the user's avatar to slide around when trying to stay stationary as well as increase the time it takes to gain momentum due to the low friction.

FIG. 6A is a detailed block diagram of the Rules Module. Once all board and piece data have been denotated 610, the rules module 612 may further process the VBE objects. Some of but not all the responsibilities of the rules system are to define the active environment space, behaviours, actions, action consequences, action constraints, mechanics, goals and objectives. VBE objects may represent applied system mechanics containing but not limited to virtual attributes, visual representation and actions within the VBE.

The term “mechanics” is defined as thematically influenced rules system as applied to any object or element within the VBE.

In some embodiments, a combination of further processing may be required to enable the piece to have the correct characteristics and behaviours that are expected by the user within the current theme. The pieces may have attributes attached per step or module 680 in FIG. 6A. Attributes are sets of key/value pairs of information relating to said piece. Initial State may be set per 682 in FIG. 6A. State is a value of an attribute at a given time. Actions may be applied, for example per 684 in FIG. 6A. Actions, at their most basic, are the ability for an object to change its state or the state of other objects. Actions may also apply AI or AI routines to an agent, this allows for intelligent-like, autonomous behaviours essentially dictating the behaviours of the characters in the virtual world. Constraints may be applied per 686 in FIG. 6. Constraints may include limitations on actions or state changes.

The unique interplay of attached actions 684 and constraints 686 within objects contained in the VBE forms the applied system mechanics 688. Mechanics may be determined by the derived theme 606 as well as the rules system that have been applied to the system. System mechanics may be further defined in other embodiments of the system including but not limited to gaming, open world exploration, music or sound creation, robotics programming, learning physics and physical interaction systems along with other educational uses.

Mechanics may be attached to any object or element within the VBE. Examples of elements may be, but are not limited to, power-ups, enemy spawn points, structural elements, avatars, vehicles and autonomous agents. Autonomous Agents can act independently, possibly reacting dynamically to stimuli. In some embodiments, examples of autonomous agents may be but limited to enemies seeking out the avatar, vehicles that the avatar can pilot and non-player characters (NPCs) which may allow user interaction, completion of goals or to allow the unfolding of storyline plot elements.

Emergent behaviour is the resultant outcome of real-time interactions between loosely coupled mechanics, according to an example embodiment.

The term “emergent behaviour” or “emergence” at its most basic, is interactivity within a non-linear, digital experience. Emergence is the result of rules that govern, but not absolutely enforce, many possible outcomes.

In one embodiment, the user may have constructed a board with a plurality of placed pieces along with a platformer theme piece 118 as shown in FIG. 1 and rules system or module 612 in FIG. 6A may instruct the VBE to respond to the user in a side-scrolling game context 200 as shown in FIG. 2. Within this embodiment and theme, the rules system influences may include, but are not limited to, defining the actions and abilities of the avatar 212 FIG. 2, defining what the user's interaction control mechanisms are and defining the play mechanics of the avatar amongst other things. General enemy 216 characteristics may include, enemy behaviour types (if they are sneaking, observing, hunting), AI rules, where and how often they may spawn, how they can be defeated and what type of defeat reward there is.

Board or level characteristics may include: environmental look and feel 210, environment specific 3D models such as stairs 242, platform blocks 240 and 244, collectible types 218, power-up types 246, types of enemies and numbers of enemies.

In one embodiment with a side-scrolling theme in place, the user has direct control over their avatar and the actions that are taken. Proactive emergence allows the user to decide what path to take, what puzzles to solve, how to solve them. Furthering this example, the user needs to collect a key which is in the control of an enemy agent. Due to an emergent rules system the user has a number of different ways to accomplish this, either choosing to directly attack the enemy guard or choosing a more stealthy approach. In this example the user has decided upon the stealth. In order to get the key, the user needs to create a distraction to get the enemy autonomous agent to leave room. In this example the user controlled avatar pushes a box off a platform ledge resulting in a loud sound. The loud sound alerts the enemy who leaves the room, with room no longer guarded the user controlled avatar jumps down off platform and sneaks into room. Avatar grabs key and uses key to unlock door thus accomplishing the set goal for the level.

In one embodiment, an identified stack piece 214 in FIG. 2 may be an enemy spawn point or generator from which virtual enemy characters or autonomous agents are released from. This enemy 216 is tasked with seeking out and causing damage to the user's avatar. Attributes attached to the spawn point 214 may be, but are not limited to, location within the VBE coordinate system, frequency of enemy generation and type of enemy generated. Attributes attached to the enemy 216 may be, but not limited to, position, health, weapon type, ammo type, jumping ability and movement velocity. The state of this enemy is also initialised, this state may be but not limited to, starting position in the virtual environment, starting health points, starting weapon and amount of ammo and Constraints are set, for example how high enemy can jump and the walk and run velocity.

In another example, a piece 219 is identified and its virtual representation is that of a power up. In a side-scrolling platformer embodiment, this power up may give the avatar faster running speed or higher jumping ability or temporary invincibility to harm. The power up makes changes to the underlying avatar attributes, state and actions that may have a temporary or lasting effect.

According to an example embodiment of the present invention, referring to FIG. 2, a goal piece 218 is identified. Goals are a condition the user may need to meet in order to progress within the VBE. In some embodiments, achieving one or more goals is the object of the entire play session. In other embodiments, the goal may be to reach to top of the board before a timer has run out. In yet another embodiment, the goal may be to rescue a creature being held captive by an evil wizard, with another theme in place the goal may be to race around a field with the user's avatar riding a horse and successfully jump barrels. In yet other embodiments and combinations of theme(s) and rule(s) the very act of interacting with the VBE is the objective with no pre-set Goals or objectives. The pure enjoyment and discovery of the created environment from the user's own imagination is reward in and of itself.

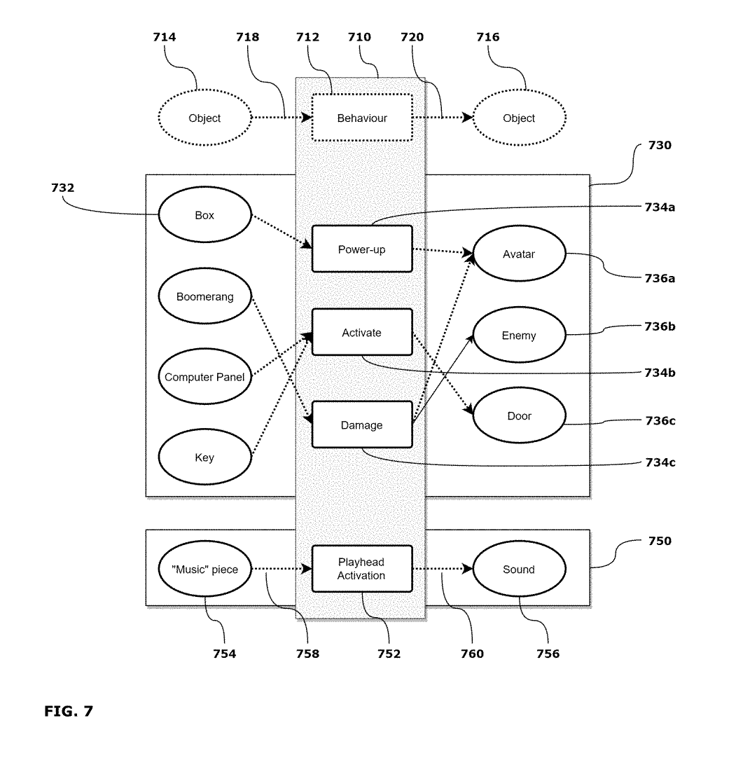

FIG. 7 schematically depicts an emergent structure based on a loosely coupled mechanics system. Emergent structure is the design layers that allow for a few rules to come together in novel and unexpected ways. Mechanics are loosely-coupled to one another through a behaviour messaging bus 710 which allows for a publish 718 and subscribe 720 type messaging system. An object with contained mechanics 714 may publish a relevant behaviour 712 into the messaging channel. The messages are enqueued and broadcast out 720 to subscribed listeners 716. Objects may be loosely connected via actions or behaviours to other objects as required.

In one embodiment with reference to FIG. 7 and with a side-scrolling gaming theme as shown in FIG. 2, an example emergent rules system is illustrated in 730 with example mechanics illustrated but not limited to: arrow, box, light bulb or door. Example behaviours that may be exhibited are illustrated but not limited to: power-up 734a, activate 734b and damage 734c. Receiving objects that are set to listen to the behaviours are illustrated as but not limited to the user controlled avatar 736a, enemy AI 736b and a door 736c.

In another embodiment with a music creation theme as shown in FIG. 2D, an example emergent rules system is illustrated in 750 with example mechanics illustrated but not limited to an identified music piece 754 attached to a board. In this example the piece 754 publishes a message whenever the virtual track playhead has “passed” 752 over it. The outcome is a musical sound 756 that is subscribed 760 is output to the environment engine's audio system 540 in FIG. 5.

Users may make changes to these relationships by changing how objects, mechanics and behaviours are interconnected. This may be accomplished with a number of mechanisms some of which are: within an app located on a device, within a cloud based interface or directly on the board using specific combination of specific or non-specific rules type pieces.

It is to be noted that the above examples illustrated in FIG. 7 are purely for explanation and illustrative purposes only. There are nearly limitless combinations of mechanics and interconnections across embodiments, themes and applied rules systems, as will be appreciated by a person skilled in the art.

In some embodiments, the user may make changes or alterations to the applied rules, behaviours and mechanics. This configuration ability may allow for a nearly unlimited number of customisations and changes to such things as, but not limited to, how objects are connotated, what rules are applied to the objects, what constraints are in place on the objects as well as the mechanics interactions between objects. Configuration may be possible from within an app or may be from developing custom configuration.

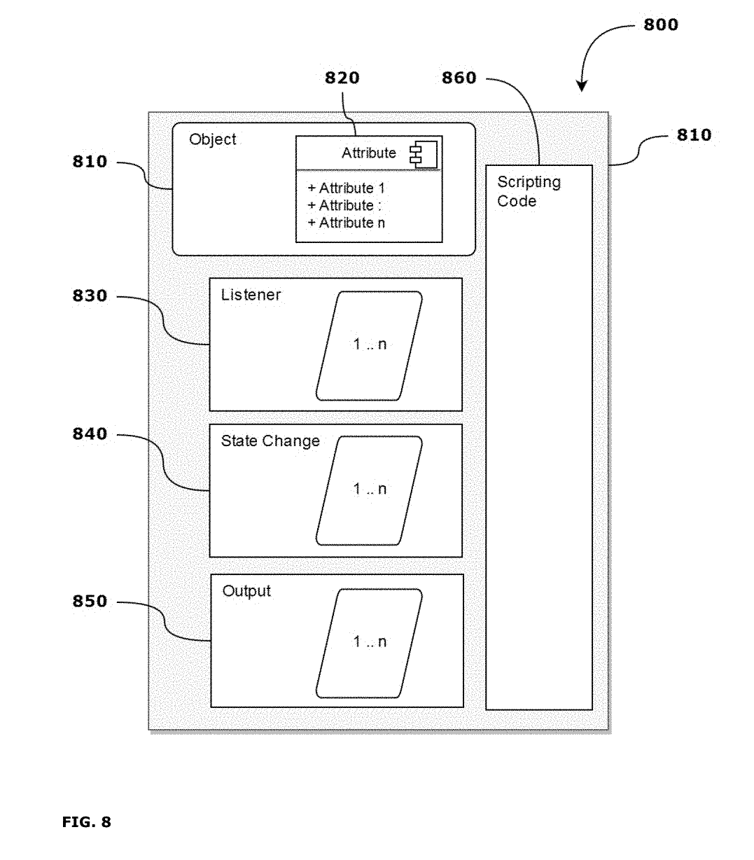

FIG. 8 depicts a block diagram of an example custom rules module according to an example embodiment. The rules module 810 may consist of an object definition 810, one or more object attributes 820, one or more channels 830 to broadcast messages into, one or more possible state changes 840 that may result, one or more outputs 850 that are affected by state change 840 and any additional scripted instructions 860 that may add additional novel characteristics to rules module. Users will be able to take the existing rules systems, adapt them in various ways and make them their own. This can be done via the app, via the UI interface or by writing custom playing environment plugins, using the scripting engine 590 FIG. 5, that can be shared via code sharing systems or social networks.

This also works for e.g. a music context, an explorer context, robotics or physics in different example embodiments. Just by changing one parameter unexpected results may occur.

The next section describes devices utilised by the platform according to example embodiments of the present invention.

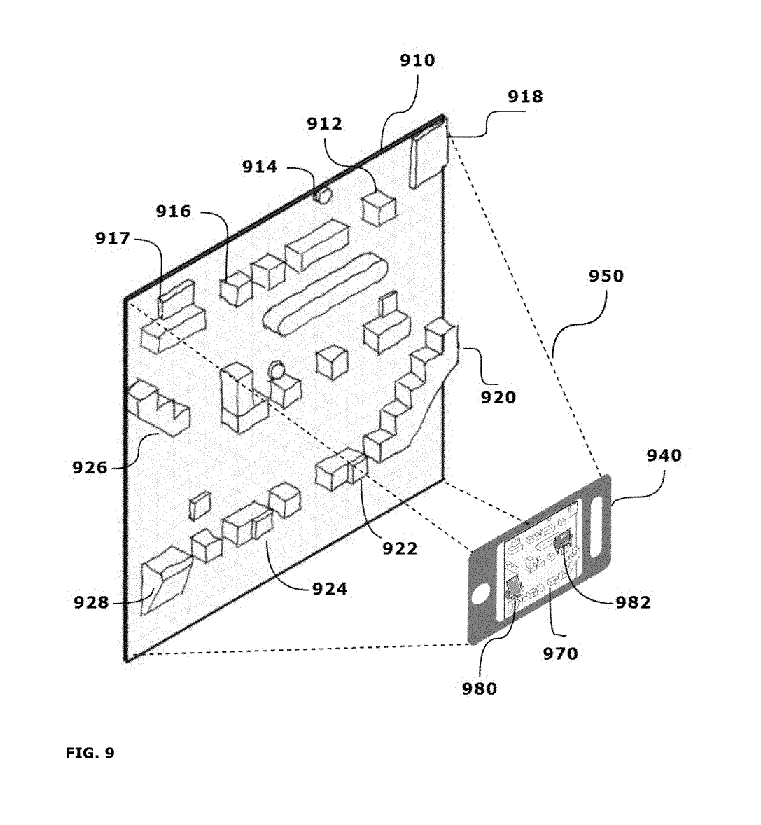

FIG. 9 schematically depicts user visualisation via an AR/MR device 940 in accordance with one embodiment. The physical board 910 with a plurality of pieces, but not limited to 916, 920, 926 and 928 are captured (compare step or module 162 in FIG. 1A) and processed along with the rules, which define the interaction, are in place (compare 166 in FIG. 1A) resulting in a fully realised, interactive 3D world or VBE 970. The VBE 970 is visualised via an Augmented Reality or Mixed Reality type device (AR/MR) 940. Typically, AR/MR type devices 940 have an array of sensors dedicated to detecting the physical environment 950. These sensors may allow for things like spatial mapping, depth sensing and image capture amongst other abilities. Device 940 allows for virtual 3D objects, scaled to the correct size, to appear in relation to and with spatial accuracy on the device 940 and have the appearance of being overlaid on the physical environment 910. VBE interactive objects including but not limited to avatars 980, autonomous enemy agents 982, characters and power-ups may appear in-place on the board 970 and in relation to their physical piece counterparts 920 and 928. Piece 920 has the virtual characteristics of a set of stairs and the user's avatar may interact with the stairs by moving up or down or jumping from the stairs. Structural pieces 912, 916 may take on the attributes of a virtual floor where Virtual Objects can collide with them and freely move over.

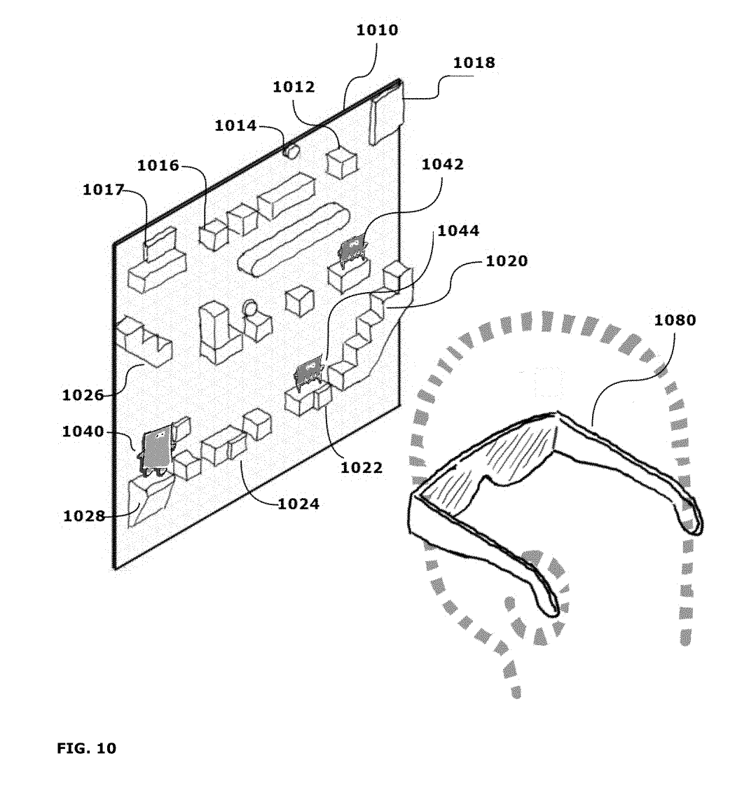

FIG. 10 is a schematic diagram of user visualisation via a body mounted or wearable AR or MR type of device 1080 in accordance with some embodiments of the present invention. The AR/MR device 1080 may be a HMD or glasses. These types of devices are generally worn on the user's head with a visor or glasses that the user looks through. The computer visuals are projected onto the user's field of view, creating an immersive, playable experience where virtual 3D objects appear in relation to and with spatial accuracy onto real world objects. These systems allow for scaling of virtual objects to give them a representational ratio that the user may expect as if the virtual object were to actually exist in the real world. VBE interactive objects illustrated are but not limited to: avatar 1040, autonomous enemy agents 1042 and 1044, goals 1017 and power-ups 1014, may appear in-place on the board and in relation to their physical piece counterparts.

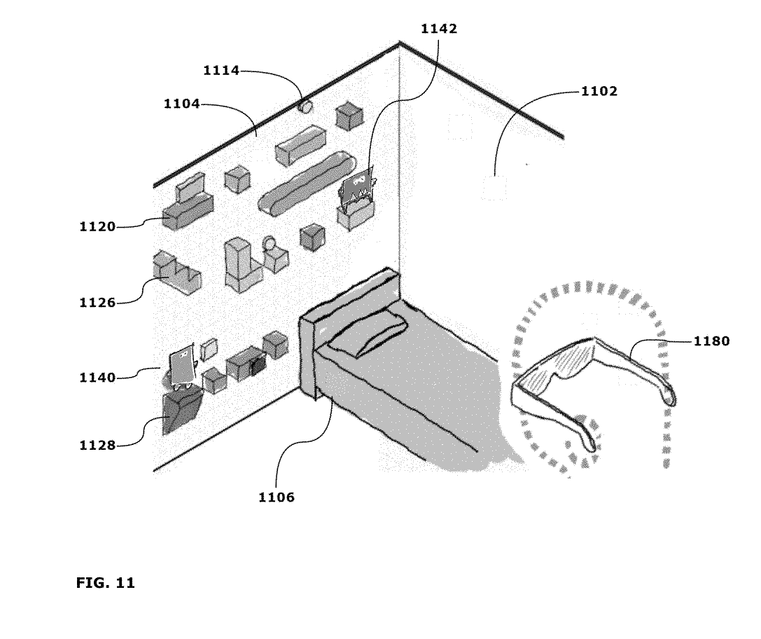

In another embodiment of the present invention, referring to FIG. 11, the user may use an AR/MR type device that is worn on their head. User is wearing a head mounted device 1180. A board with pieces has been captured previously and the VBE processed (per steps or modules 164 and 166 in FIG. 1A) within the system. The environment engine 3D graphics 530 in FIG. 5 are projected onto the user's field of view, creating an immersive, playable experience where virtual 3D objects appear in relation to and with spatial accuracy onto real world objects, illustration shows a real-world room 1102 with real-world bed 1106 and the VBE is being overlaid on top of a wall 1104. In this example, the user is free to move about and interact with the VBE interactive objects including but not limited to: avatar 1140, autonomous agents, enemies 1142, platforms 1120 and 1128, stairs 1126 and power-ups projected into real space.

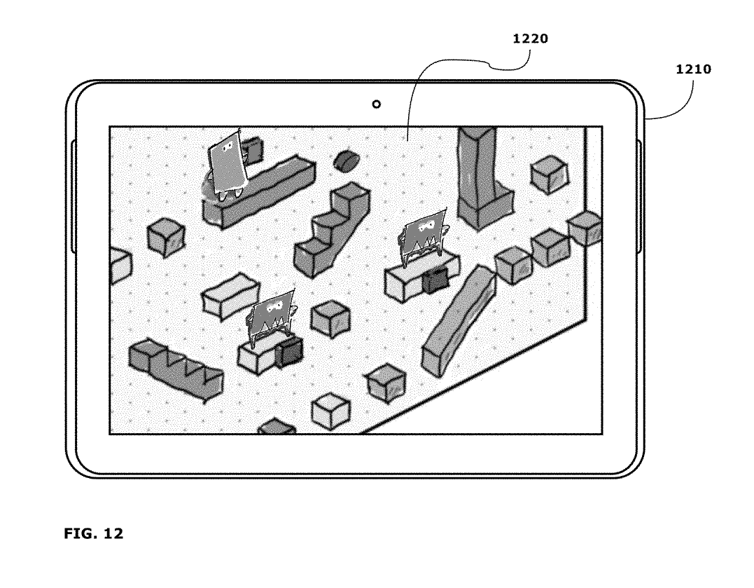

FIG. 12 schematically depicts VBE visualisation on a tablet device 1210 according to an embodiment of the present invention. In this embodiment, the physical board and plurality of pieces have been captured (per step or module 162 in FIG. 1A) and the rules defining the game are in place (per 166 in FIG. 1A) resulting in a fully realised, interactive 3D world or VBE. The user is free to move away from the physical board and interact with the VBE entirely on tablet device 1210. The user may have a number of points of view into the VBE including a first-person perspective, a third person perspective, an isometric view 1220, a 2D or 2.5D side scrolling perspective, a top down view or a floating camera view. Each of these views may provide a different interactive style that suits a wide variety of game genres and styles. Examples of other devices suitable for this embodiment are many with a non-exhaustive list of: computer or laptop with screen (may be touch enabled), mobile phone with touch screen, mobile device or tablet with touch screen or dedicated gaming unit with screen (may be touch enabled).

In another embodiment, a user may visualise the VBE via an image projection system with the virtual environment being projected onto a board or other such surface such as, but not limited to a wall, table, canvas, white screen or any flat surface.

In another embodiment, the user may use a virtual reality or VR type device that is worn on their body. This creates a fully immersive, playable experience where the VBE takes up the user's entire field of view and 3D objects appear in relation to and with spatial accuracy as the User moves their head and body. All interactive components (avatars, characters, enemies, power-ups, etc.) are displayed with their virtual representation supplanting any physical view.

In yet another embodiment, the user may visualise state changes along with graphics and lights directly on the board. In this embodiment the board is a smart board containing a plurality of circuitry and sensors which combined create a framework or detection network that identifies placed Pieces and recognises the placed Piece characteristics. The embedded sensor network would respond to pieces that may be static or pieces that may themselves contain circuitry, sensors and/or transmitters.

The next section describes interaction step or module 168 in FIG. 1A between the user and the physical/virtual representations according to the present invention.

In some embodiments, to change the state of and interact with the rules and mechanics of the VBE, a number of devices may be used but not limited to, touch sensitive screen, keyboard, mouse or a game controller or some other input device.

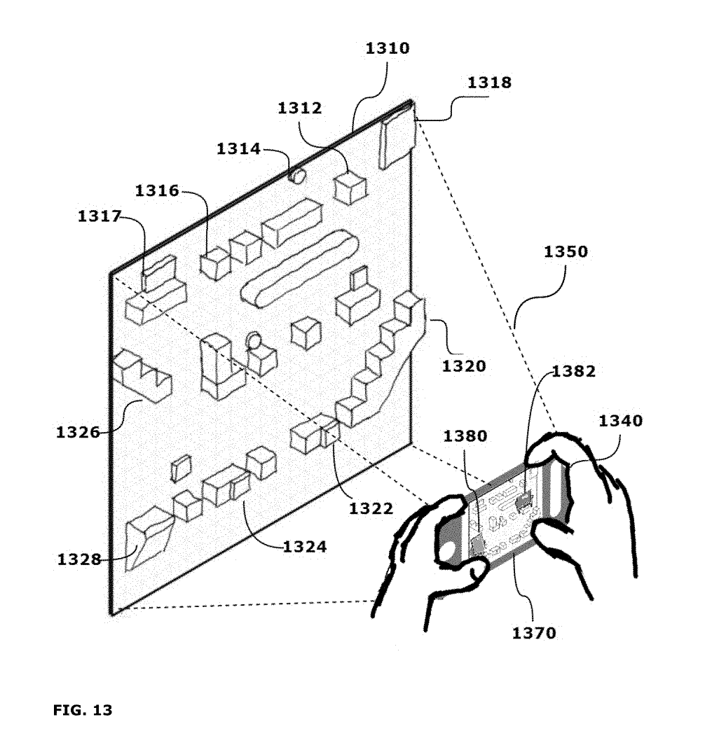

FIG. 13 schematically illustrates a user interacting with a touch screen AR/MR device 1340. In one embodiment, further interaction is depicted which displays a virtual avatar 1380 superimposed upon the physical board 1310 on the AR device's 1340 multi-touch screen 1370. The avatar 1380 begins at start piece 1328 spawn point with an enemy generated at an enemy spawn point 1322. All physical pieces 1312, 1316, 1320, 1326 and 1328 have been fully initialised in the VBE and are fully interactive to the user. The user interacts with the avatar with touch gestures as is common in mobile type games. An example interaction, but not limited to, is the user may swipe right to have the avatar 1380 move in the right direction relative to the VBE coordinate space. In this example the user is maneuvering their avatar to avoid the enemy and reach the power-up at 1314. The connection with the board 1310 is in real-time, if the user moves the AR/MR device 1340 relative to the board, all virtual on-screen objects continue to appear in sync and in-place on top of the physical board.

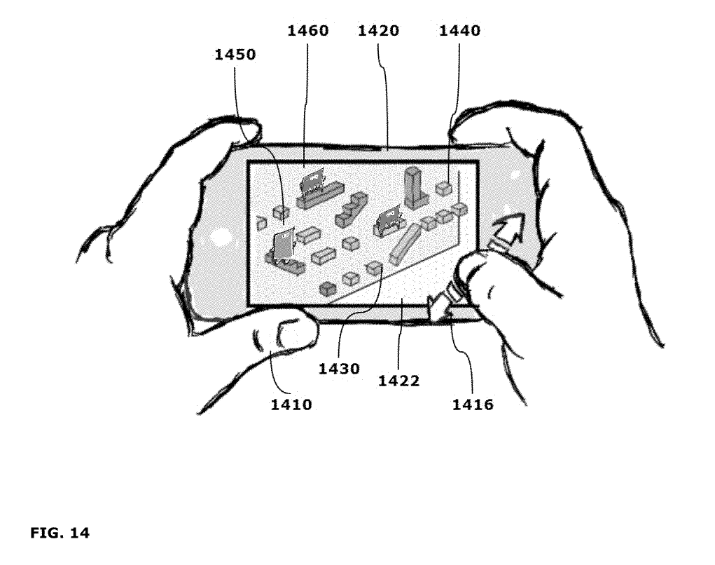

FIG. 14 illustrates VBE interaction via a mobile device 1420 that does not have AR/MR capabilities. The user 1410 may interact with the VBE through a device 1420 with a touch screen interface 1422. In this embodiment, all previous steps have been completed (per work-flow or modules 160-168 in FIG. 1A) resulting in a fully realised, interactive 3D world or VBE 1430. The user may move away from the physical board and interact entirely on device 1420. The user may have a number of points of view into the VBE including a first-person perspective, a third person perspective 1430, a 2D or 2.5D side scrolling perspective, a top down view or a floating camera view. Each view provides a different interaction style that suits a wide variety of game genres and styles. An example of this in one embodiment is the user holding a smart phone as the mobile device 1420 with their avatar 1450 appearing on the screen within a 3D graphically generated VBE 1430. In this embodiment, the user 1410 may swipe 1416 the screen 1422 to move the avatar around the game level.

Revisiting FIG. 10, in accordance with an example embodiment, a user may interact with an AR/MR environment without the need for a hands-on device. The user may use hand gestures, body movements, eye tracking or other body movements to control user interface functions, such as moving the avatar, scrolling and selecting, thus interacting with the VBE. The user is not required to use a mouse, keyboard or other physical device to interact with the virtual system. Speech recognition may also be used to translate a user's spoken words or sounds into computer instructions.

The user may interact entirely using the underlying abilities of the AR hardware which includes the worn device 1080 or may use a controller typical of a gaming system (such as an Xbox controller or the like) or may be via a mouse or keyboard or other input mechanism.

In some embodiments, the user may interact with the VBE through a device such as a computer with screen, laptop or dedicated gaming system. These devices may or may not have a touch screen interface. In such embodiments, all previous steps have been completed (per work-flow or modules 160-168 in FIG. 1A) resulting in a fully realised, interactive 3D world or VBE, for example VBE 1430 in an example embodiment using a smart phone 1420. The user may not need to be in proximity to the board and is free to move away from the physical board and interact entirely on said device. The user may have a number of points of view into the VBE including a first-person perspective, a third person perspective 1430, a 2D or 2.5D side scrolling perspective, a top down view or a floating camera view. Each view provides a different interaction style that suits a wide variety of game genres and styles. In this embodiment, the user may swipe the screen if they are using a system with a touch screen. Otherwise they may use a combination of keyboard, mouse, controller or similar input system.

In some embodiments, a user may have an array of playable avatars or characters available to interact with. Each character may have unique abilities and these abilities may be customisable either from an in-app UI, via a shared character discovered via a social network or by customisable rules module. Character choice may be decided upon by the user or the avatar choice may be influenced by the derived theme. As the user progresses interaction with a plurality of boards or levels, certain VBE system abilities may be “unlocked”. These abilities may include but not limited to the ability to enhance or customise their character, ability to provide additional traits or tools, ability to purchase power-ups or equipment and the ability to trade certain virtual equipment.

In some embodiments, the system may be playable by one or more users.

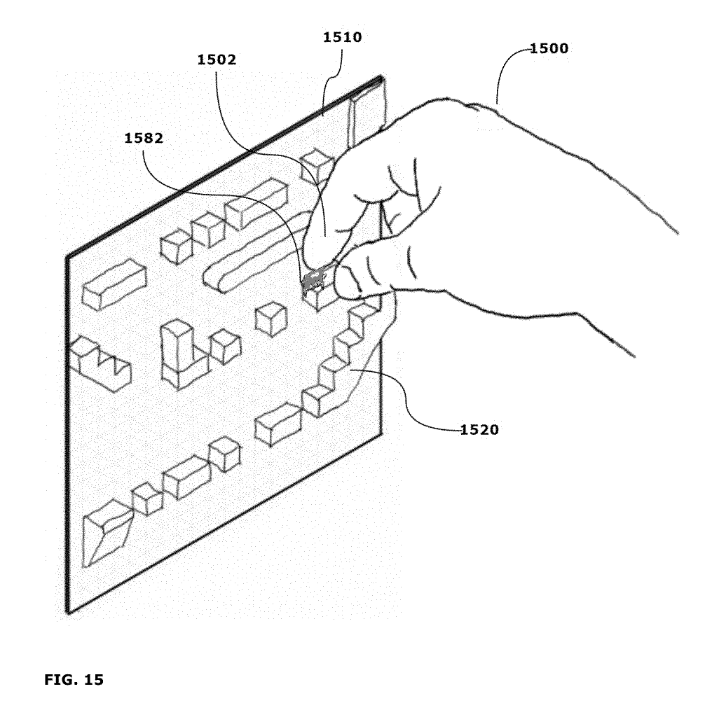

FIG. 15 is a schematic illustration of a user 1500 interacting with a piece. In some embodiments, user interaction may in additional to input methods previously mentioned, take the form of physically altering the pieces such as removing, adding or moving a piece. This has a direct, real-time effect on the VBE interaction with the board 1510. The VBE will re-compute all physics, for example, a virtual enemy 1582 is standing on a structural piece, user 1500 picks up piece 1502 and removes it, enemy falls down to lower platform 1520 according to engine physics (compare 550 in FIG. 5).

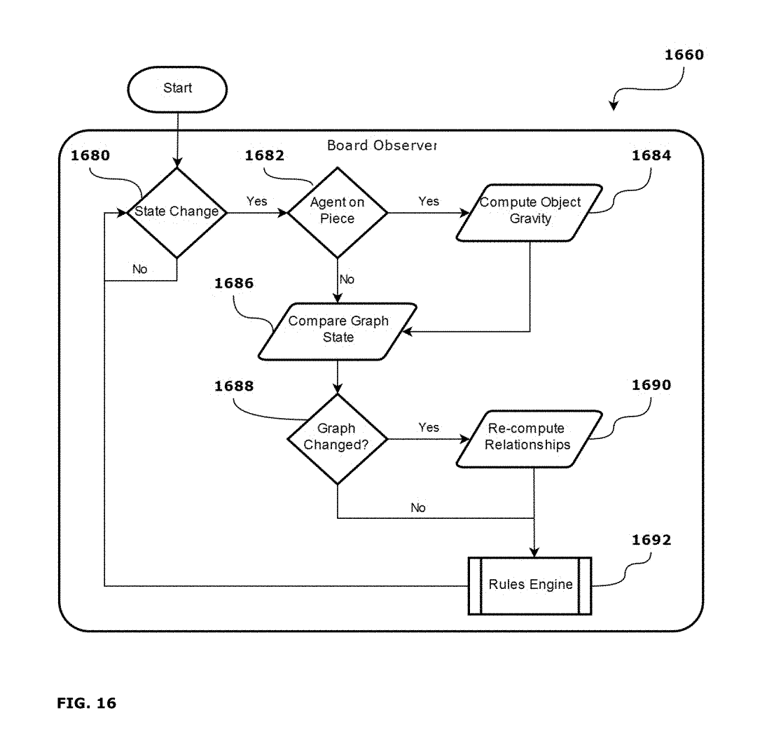

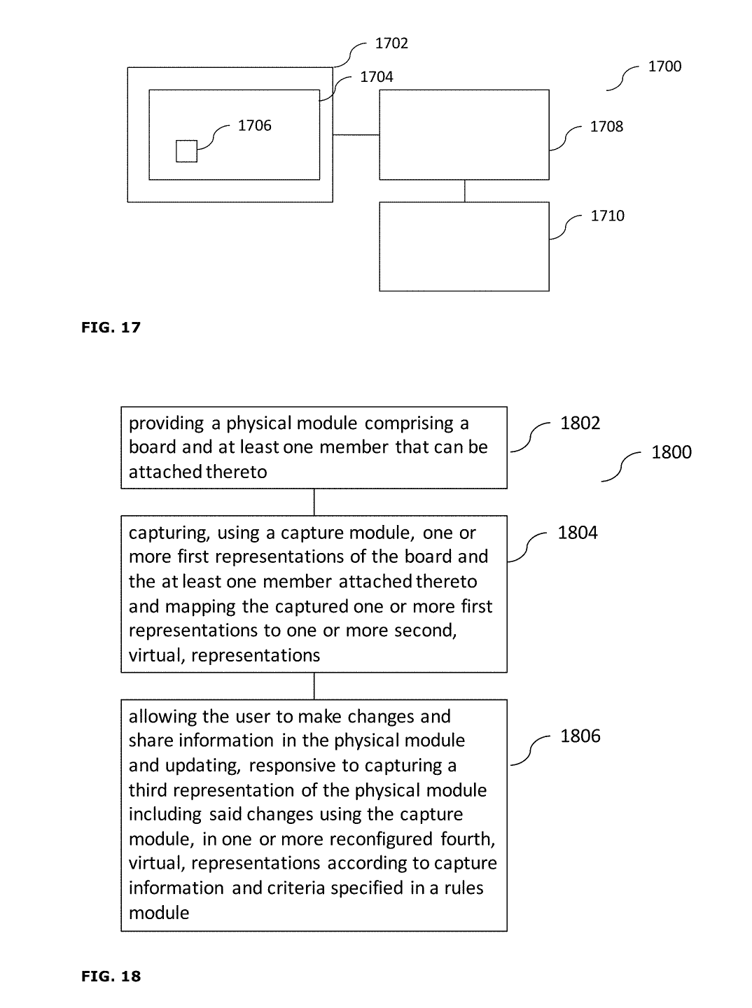

FIG. 16 depicts a block diagram of a board observer module 1660 according to an example embodiment of the present invention. Real world interaction (e.g. such as described above with reference to FIG. 15) with pieces results in direct and immediate change within the VBE. Board observer module 1660 runs in the background constantly observing the board and looking for state change 1680 e.g. using the capture module (compare 162 in FIG. 1A). If a state change operation occurs a check is run 1682 to see if a virtual 3D agent is interacting with piece that has had a state change. If an agent is involved 1684 any computed physics are applied to virtual agent. If no agent is interacting with piece that has had state change, the piece graph state is compared 1686. This operation checks if any new piece or pieces have been added 1688 and if so the piece network is re-evaluated 1690 to see if any stack pieces have been created therefor causing new virtual objects to be added or removed from VBE. If no new piece or pieces have been added the rules engine module 1692 is accessed to update any relevant game rules.

In yet another embodiment, the user may interact directly with a plurality of physical pieces without the need of an external visual aid or device. In such an embodiment, the board can be a smart board containing a plurality of circuitry and sensors which combined create a framework or detection network that identifies placed pieces and recognises the placed piece attributes. The embedded sensor network would respond to pieces that may also be static shapes or pieces themselves containing circuitry, sensors and/or transmitters. The user would visualise state changes directly on the board.

If a user desires to customise their experience they can change the abilities of the board along with assembled plurality of pieces, according to example embodiments. Such customisation makes use of the rules module (compare step or module 166 in FIG. 1A) and may include themes or changes to themes.

When a user customises their experience by changing the abilities of the board along with the piece(s), such customisation would preferably be saved for further reference by the user.

In some embodiments, the theme piece may be swapped with another theme piece or the user may add additional theme pieces to the board. This may create new novel system behaviour within the VBE. In an example embodiment, any state changes to the theme will result in the board observer module FIG. 16 being run, as described above.

Following, for example, along with the side-scrolling game 200 in FIG. 2, the side-scrolling theme can be removed and replaced with a castle theme piece, refer to FIG. 2A. With this new theme in place, structural pieces may be transformed from being a set of stairs to a castle wall, an ice platform block into a treasure chest, an enemy spawn point into a wizard's cauldron.

In another embodiment, the castle theme piece in FIG. 2A is switched with an ocean theme piece. For example, board layout 231 FIG. 2A becomes an underwater coral reef with previous walls, rooms and floors becoming reefs, islands, shipwrecks, and water.

All aspects of the platform as customised by the user can be shareable according to example embodiments, for example, but not limited to: developed/adapted rules are shareable, pieces and behaviours are shareable, the entire level or built board is shareable.

In one embodiment, a system 1700 for linking virtual and physical activities is provided. The system 1700 comprises a physical module 1702 comprising a board 1704 and at least one member 1706 that can be attached thereto, a capture module 1708 configured for capturing one or more first representations of the board 1704 and the at least one member 1706 attached thereto and maps the captured one or more first representations to one or more second, virtual, representations, and a rules module 1710, wherein the physical module 1702 is configured for allowing the user to make changes and share information in the physical module 1702 and the capture module 1708 is configured for updating, responsive to capturing a third representation of the physical module 1702 including said changes, in one or more reconfigured fourth, virtual, representations according to capture information and criteria specified in the rules module 1710 and wherein the rules module 1710 is configured for specifying one or more interaction rules for interaction of a user with any one or more of the first, second, third and fourth representations.

The physical module 1702 may comprise one or more theme identification members, and the rules module 1702 may be configured for specifying the user interaction based on theme categories corresponding to respective ones of the one or more theme identification members.

The system 1700 may be configured for pre-set theme categories and/or user adaptable theme categories.

The physical module 1702 may be configured for user-controlled attachment of the one or more members 1706 to the board 1704 and the rules module 1710 is configured for specifying the user interaction based on a change in attachment of the one or more members 1704.

The rules module 1710 may be configured for pre-set criteria and/or user adaptable criteria.

The board 1704 may be substantially planar.

The board 1704 may be three dimensional.

Physical characteristics of the board 1704 captured and stored by the capture module 1708 may include spatial and orientation data between the board 1704 and the attached member 1706 and between members 1706.

The rules module 1710 may be configured for providing for physical interactivity between the user and the one or more members 1706 to be updated in the one or more reconfigured third representations in real time.

The physical interactivity may include user changes to the physical module.

One or more of the members 1706 may be creatable by the user for attachment to the board 1704.

FIG. 18 shows a flowchart 1800 illustrating a method for linking virtual and physical activities according to an example embodiment. The method comprises providing a physical module comprising a board and at least one member that can be attached thereto at step 1802, capturing, using a capture module, one or more first representations of the board and the at least one member attached thereto and mapping the captured one or more first representations to one or more second, virtual, representations at step 1804, and allowing the user to make changes and share information in the physical module and updating, responsive to capturing a third representation of the physical module including said changes using the capture module, in one or more reconfigured fourth, virtual, representations according to capture information and criteria specified in a rules module at step 1806, wherein the rules module specifies one or more interaction rules for interaction of a user with any one or more of the first, second, third and fourth representations.

The rules module may specify the user interaction based on theme categories corresponding to respective ones of the one or more theme identification members.

The theme categories may be pre-set and/or user adaptable.

The method may comprise user-controlled attachment of the one or more members to the board and the rules module specifies the user interaction based on a change in attachment of the one or more members.

The criteria may be pre-set and/or user adaptable.

The board may be substantially planar.

The board may be three dimensional.

The method may comprise storing physical characteristics of the board captured and stored by the capture module, include spatial and orientation data between the board and the attached member and between members.

The rules module may provide for physical interactivity between the user and the one or more members to be updated in the one or more reconfigured fourth representations in real time.

The physical interactivity may include user changes to the physical module.

The method may comprise the user creating the members for attachment to the board.

In one embodiment, a system for linking virtual and physical activities is provided comprising a system management platform, a physical module consisting of a board and at least one member that can be attached thereto, a capture module that identifies physical module representations and maps to virtual representations, and a rules module that specifies interaction between representations and a user, wherein the platform allows a user to make changes and share information in the physical module and those changes are updated in a reconfigured virtual representation according to capture information and criteria specified in the rules module.

The interaction between the representations and the user may be categorised into themes and wherein the themes can be pre-set by the platform or developed or adapted by the user.

In one embodiment, a method for linking virtual and physical activities is provided comprising a user creates a member within a physical module, a capture module identifies physical module representations and maps to virtual representations,

the user controls the member to change its physical attributes, the capture module updates the virtual representations, a rules module examines interaction between the representations and the user, wherein a system management platform updates the reconfigured virtual representation in real time according to the capture information provided by the capture module and criteria specified in the rules module.

The platform, system, and/or methods described according to example embodiments that links activities across physical and virtual worlds has many advantages. The user can build or update aspects of the world(s) and develop their own methodology.

The platform, system, and/or methods described according to example embodiments allow users that are seeking new gaming relationships the ability where an individual player can leave their mark on the platform and their individual style can be expressed as they approach problem solving in ways entirely unique to themselves.

The platform, system, and/or methods described according to example embodiments can provide a game type platform where each user may respond differently in a given situation, employing unique strategies, problem solving in many different ways, expressing their creativity. This emergent behaviour may help to remove the “right way” or “only way” to achieve goals in a game—the individual can think for themselves and come up with their own methodology.

The platform, system, and/or methods described according to example embodiments can provide a platform where users can implant their version, their personality into game interactions, from building worlds to creating music tracks to beating the fastest time on a level just shared by their friends. The platform, system, and/or methods described according to example embodiments “gamify the game” by giving users the ability to make, adapt and share physical and virtual worlds along with the defining the very rules that make those worlds come to life.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features, in particular any combination of features in the patent claims, even if the feature or combination of features is not explicitly specified in the present embodiments.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

1. A system for linking virtual and physical activities comprising:
a physical module comprising a board and at least one member that can be attached thereto,
a capture module configured for capturing one or more first representations of the board and the at least one member attached thereto and maps the captured one or more first representations to one or more second, virtual, representations, and
a rules module,
wherein the physical module is configured for allowing the user to make changes and share information in the physical module and the capture module is configured for updating, responsive to capturing a third representation of the physical module including said changes, in one or more reconfigured fourth, virtual, representations according to capture information and criteria specified in the rules module, and
wherein the rules module is configured for specifying one or more interaction rules for interaction of a user with any one or more of the first, second, third and fourth representations.

2. The system according to claim 1, wherein the physical module comprises one or more theme identification members, and the rules module is configured for specifying the user interaction based on theme categories corresponding to respective ones of the one or more theme identification members.

3. The system according to claim 2, wherein the system is configured for pre-set theme categories and/or user adaptable theme categories.

4. The system according to any one of claims 1 to 3, wherein the physical module is configured for user-controlled attachment of the one or more members to the board and the rules module is configured for specifying the user interaction based on a change in attachment of the one or more members.

5. The system according to any one of claims 1 to 4, wherein the rules module is configured for pre-set criteria and/or user adaptable criteria.

6. The system according to any one of claims 1 to 5, wherein the board is three dimensional.

7. The system according to any one of claims 1 to 6, wherein physical characteristics of the board captured and stored by the capture module include spatial and orientation data between the board and the attached member and between members.

8. The system according to any one of claims 1 to 7, wherein the rules module is configured for providing for physical interactivity between the user and the one or more members to be updated in the one or more reconfigured third representations in real time.

9. The system according to claim 8 where the physical interactivity includes user changes to the physical module.

10. The system according to any one of claims 1 to 9, wherein one or more of the members are creatable by the user for attachment to the board.

11. A method for linking virtual and physical activities comprising:
providing a physical module comprising a board and at least one member that can be attached thereto,
capturing, using a capture module, one or more first representations of the board and the at least one member attached thereto and mapping the captured one or more first representations to one or more second, virtual, representations, and
allowing the user to make changes and share information in the physical module and updating, responsive to capturing a third representation of the physical module including said changes using the capture module, in one or more reconfigured fourth, virtual, representations according to capture information and criteria specified in a rules module,
wherein the rules module specifies one or more interaction rules for interaction of a user with any one or more of the first, second, third and fourth representations.

12. The method according to claim 11, wherein the rules module specifies the user interaction based on theme categories corresponding to respective ones of the one or more theme identification members.

13. The method according to claim 12, wherein the theme categories are pre-set and/or user adaptable.

14. The method according to any one of claims 11 to 13, comprising user-controlled attachment of the one or more members to the board and the rules module specifies the user interaction based on a change in attachment of the one or more members.

15. The method according to any one of claims 11 to 14, wherein the criteria are pre-set and/or user adaptable.

16. The method according to any one of claims 11 to 15, wherein the board is three dimensional.

17. The method according to any one of claims 11 to 16, comprising storing physical characteristics of the board captured and stored by the capture module, include spatial and orientation data between the board and the attached member and between members.

18. The method according to any one of claims 11 to 17, wherein the rules module provides for physical interactivity between the user and the one or more members to be updated in the one or more reconfigured fourth representations in real time.

19. The method according to claim 18, wherein the physical interactivity includes user changes to the physical module.

20. The method according to any one of claims 11 to 19, comprising the user creating the members for attachment to the board.
